(19) United States
(12) Patent Application Publication
(10) Pub. No.: US 2023/0118188 A1
(43) Pub. Date: Apr. 20, 2023

(54) METHOD AND SYSTEM FOR PERFORMING OPERATIONS MAINTENANCE AND FAULT REMEDIATION

(71) Applicant: JPMorgan Chase Bank, N.A., New York, NY (US)

(72) Inventors: Anupam ARORA, Middletown, DE (US); Kumaresan THIRUVENKADAM, Glen Mills, PA (US)

(73) Assignee: JPMorgan Chase Bank, N.A., New York, NY (US)

(21) Appl. No.: 17/964,421

(22) Filed: Oct. 12, 2022

Related U.S. Application Data
(60) Provisional application No. 63/262,715, filed on Oct. 19, 2021.

(51) Int. Cl. G06F 11/07; G06N 20/00

(52) U.S. Cl. CPC G06F 11/0793; G06F 11/0709; G06N 20/00

(57) ABSTRACT

A method for performing operations maintenance and fault remediation for a network environment by using artificial intelligence and machine learning techniques to provide self-healing capabilities is provided. The method includes receiving first data that relates to the network environment; identifying a problem to be addressed by analyzing the first data; determining a proposed remedy for the identified problem by applying an artificial intelligence (AI) algorithm to the first data, and executing the proposed remedy. The AI algorithm is trained by using historical data that relates to the network environment.

### CROSS-REFERENCE TO RELATED APPLICATIONS

This application claims priority benefit from U.S. Provisional Application No. 63/262,715, filed Oct. 19, 2021, which is hereby incorporated by reference in its entirety.

### BACKGROUND

### 1. Field of the Disclosure

This technology generally relates to methods and systems for performing operations maintenance and fault remediation by using artificial intelligence and machine learning techniques to provide self-healing capabilities.

### 2. Background Information

In a large organization that broadly relies on a network environment with many software applications, typically there are information technology professionals that work as a support team to maintain the environment and remedy faults and problems that arise. However, as demand increases with respect to the number of users in each application, the support team may become overwhelmed with the number of problems that need to be addressed. This, in turn, may lead to operational delays and increased costs.

Accordingly, there is a need for a mechanism for performing operations maintenance and fault remediation by using artificial intelligence and machine learning techniques to provide self-healing capabilities.

### SUMMARY

The present disclosure, through one or more of its various aspects, embodiments, and/or specific features or sub-components, provides, inter alia, various systems, servers, devices, methods, media, programs, and platforms for performing operations maintenance and fault remediation by using artificial intelligence and machine learning techniques to provide self-healing capabilities.

According to an aspect of the present disclosure, a method for performing operations maintenance and fault remediation for a network environment is provided. The method is implemented by at least one processor. The method includes: receiving, by the at least one processor, first data that relates to the network environment; analyzing, by the at least one processor, the received first data, and identifying at least one problem to be addressed based on a result of the analyzing; determining, by the at least one processor, a proposed remedy for the identified at least one problem; and executing the proposed remedy.

The analyzing of the first data and the determining of the proposed remedy may be performed by applying an artificial intelligence (AI) algorithm to the first data. The AI algorithm may be trained by using historical data that relates to the network environment.

The AI algorithm may use at least one from among a clustering K-means library, a hierarchical clustering library, and a time series algorithms library to analyze the first data.

The AI algorithm may use a natural language processing technique to identify a user that is impacted by the at least one problem and to determine a source of the at least one problem.

The first data may include data that relates to a first application and data that identifies a user of the first application.

The method may further include generating a message that indicates a status of the identified at least one problem and transmitting the message to the user.

The method may further include: before the executing of the proposed remedy, obtaining an authorization for executing the proposed remedy; and executing the proposed remedy based on the obtained authorization.

The at least one problem may include at least one from among a user password lock, a user password expiry, a user authorization denial, a Lightweight Directory Access Protocol (LDAP) bind password issue, a browser version issue, a non-supported browser, an application crash, and a data anomaly.

The method may further include: generating a status message that includes information that relates to a status of the at least one problem; and transmitting the status message to a user that has been impacted by the at least one problem.

According to another exemplary embodiment, a computing apparatus for performing operations maintenance and fault remediation for a network environment is provided. The computing apparatus includes a processor; a memory; and a communication interface coupled to each of the processor and the memory. The processor is configured to: receive, via the communication interface, first data that relates to the network environment; analyze the received first data, and identify at least one problem to be addressed based on a result of the analysis; determine a proposed remedy for the identified at least one problem; and execute the proposed remedy.

The processor may be further configured to perform the analysis of the first data and the determination of the proposed remedy by applying an artificial intelligence (AI) algorithm to the first data. The AI algorithm may be trained by using historical data that relates to the network environment.

The AI algorithm may use at least one from among a clustering K-means library, a hierarchical clustering library, and a time series algorithms library to analyze the first data.

The AI algorithm may use a natural language processing technique to identify a user that is impacted by the at least one problem and to determine a source of the at least one problem.

The first data may include data that relates to a first application and data that identifies a user of the first application.

The processor may be further configured to generate a message that indicates a status of the identified at least one problem and to transmit the message to the user via the communication interface.

The processor may be further configured to: before the execution of the proposed remedy, obtain an authorization for executing the proposed remedy; and execute the proposed remedy based on the obtained authorization.

The at least one problem may include at least one from among a user password lock, a user password expiry, a user authorization denial, a Lightweight Directory Access Protocol (LDAP) bind password issue, a browser version issue, a non-supported browser, an application crash, and a data anomaly.

The processor may be further configured to: generate a status message that includes information that relates to a status of the at least one problem; and transmit, via the communication interface, the status message to a user that has been impacted by the at least one problem.

According to yet another exemplary embodiment, a non-transitory computer readable storage medium storing instructions for performing operations maintenance and fault remediation for a network environment is provided. The storage medium includes executable code which, when executed by a processor, causes the processor to: receive first data that relates to the network environment; analyze the received first data, and identify at least one problem to be addressed based on a result of the analysis; determine a proposed remedy for the identified at least one problem; and execute the proposed remedy.

When executed by the processor, the executable code may further cause the processor to perform the analysis of the first data and the determination of the proposed remedy by applying an artificial intelligence (AI) algorithm to the first data. The AI algorithm may be trained by using historical data that relates to the network environment.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for performing operations maintenance and fault remediation by using artificial intelligence and machine learning techniques to provide self-healing capabilities.

FIG. 4 is a flowchart of an exemplary process for implementing a method for performing operations maintenance and fault remediation by using artificial intelligence and machine learning techniques to provide self-healing capabilities.

FIG. 5 is a block diagram that illustrates a high level architecture of a system that implements a method for performing operations maintenance and fault remediation by using artificial intelligence and machine learning techniques to provide self-healing capabilities, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

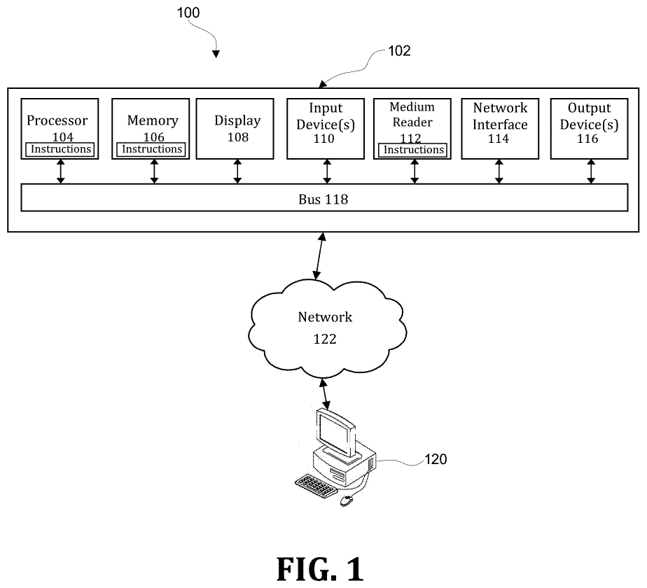

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for performing operations maintenance and fault remediation by using artificial intelligence and machine learning techniques to provide self-healing capabilities.

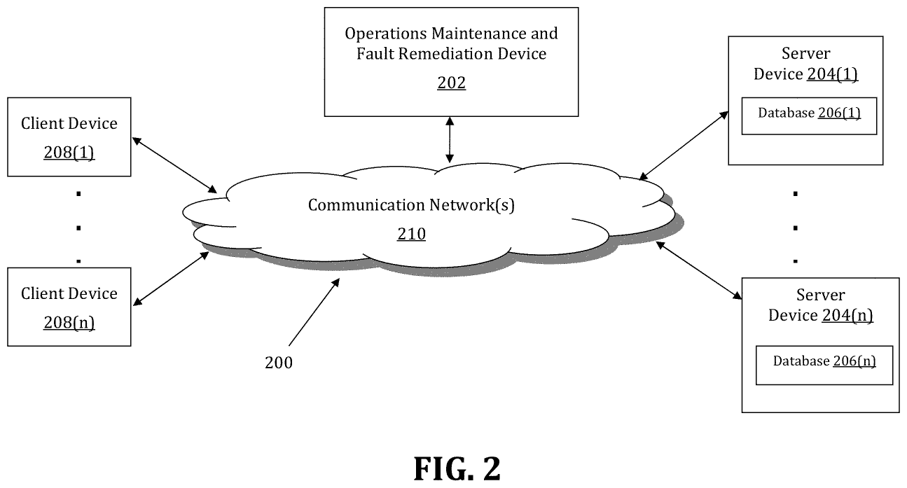

Referring to FIG. 2, a schematic of an exemplary network environment 200 for implementing a method for performing operations maintenance and fault remediation by using artificial intelligence and machine learning techniques to provide self-healing capabilities is illustrated. In an exemplary embodiment, the method is executable on any networked computer platform, such as, for example, a personal computer (PC).

The method for performing operations maintenance and fault remediation by using artificial intelligence and machine learning techniques to provide self-healing capabilities may be implemented by an Operations Maintenance and Fault Remediation (OMFR) device 202. The OMFR device 202 may be the same or similar to the computer system 102 as described with respect to FIG. 1. The OMFR device 202 may store one or more applications that can include executable instructions that, when executed by the OMFR device 202, cause the OMFR device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the OMFR device 202 itself, may be located in virtual server(s) running in a cloud-based computing environment rather than being tied to one or more specific physical network computing devices. Also, the application(s) may be running in one or more virtual machines (VMs) executing on the OMFR device 202. Additionally, in one or more embodiments of this technology, virtual machine(s) running on the OMFR device 202 may be managed or supervised by a hypervisor.

In the network environment 200 of FIG. 2, the OMFR device 202 is coupled to a plurality of server devices 204(1)-204(n) that hosts a plurality of databases 206(1)-206(n), and also to a plurality of client devices 208(1)-208(n) via communication network(s) 210. A communication interface of the OMFR device 202, such as the network interface 114 of the computer system 102 of FIG. 1, operatively couples and communicates between the OMFR device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the OMFR device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and OMFR devices that efficiently implement a method for performing operations maintenance and fault remediation by using artificial intelligence and machine learning techniques to provide self-healing capabilities.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The OMFR device 202 may be a standalone device or integrated with one or more other devices or apparatuses, such as one or more of the server devices 204(1)-204(n), for example. In one particular example, the OMFR device 202 may include or be hosted by one of the server devices 204(1)-204(n), and other arrangements are also possible. Moreover, one or more of the devices of the OMFR device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the OMFR device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical operations maintenance data and data that relates to fault remediation status.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the OMFR device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the OMFR device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the OMFR device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the OMFR device 202, the server devices 204(1)-204(n), or the client devices 208(1)-208(n), for example, may be configured to operate as virtual instances on the same physical machine. In other words, one or more of the OMFR device 202, the server devices 204(1)-204(n), or the client devices 208(1)-208(n) may operate on the same physical device rather than as separate devices communicating through communication network(s) 210. Additionally, there may be more or fewer OMFR devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

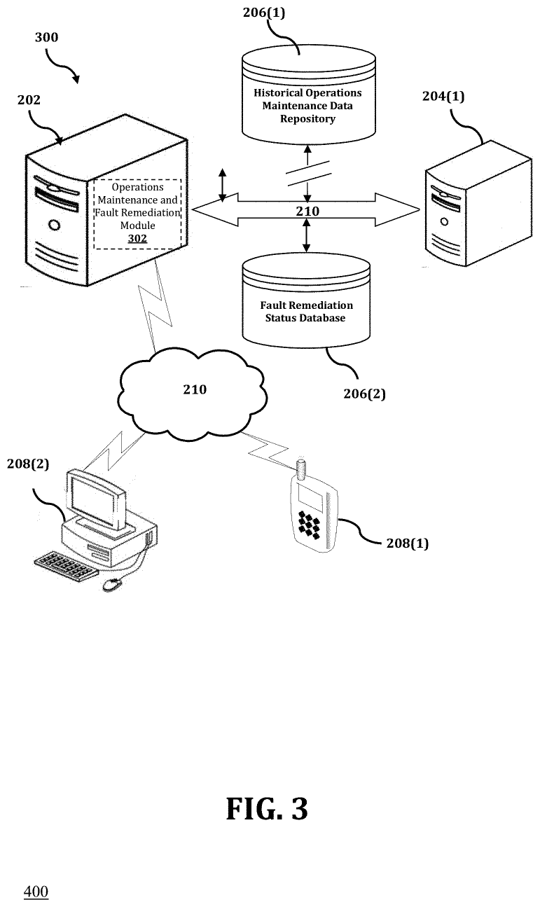

The OMFR device 202 is described and illustrated in FIG. 3 as including an operations maintenance and fault remediation module 302, although it may include other rules, policies, modules, databases, or applications, for example. As will be described below, the operations maintenance and fault remediation module 302 is configured to implement a method for performing operations maintenance and fault remediation by using artificial intelligence and machine learning techniques to provide self-healing capabilities.

An exemplary process 300 for implementing a mechanism for performing operations maintenance and fault remediation by using artificial intelligence and machine learning techniques to provide self-healing capabilities by utilizing the network environment of FIG. 2 is illustrated as being executed in FIG. 3. Specifically, a first client device 208(1) and a second client device 208(2) are illustrated as being in communication with OMFR device 202. In this regard, the first client device 208(1) and the second client device 208(2) may be “clients” of the OMFR device 202 and are described herein as such. Nevertheless, it is to be known and understood that the first client device 208(1) and/or the second client device 208(2) need not necessarily be “clients” of the OMFR device 202, or any entity described in association therewith herein. Any additional or alternative relationship may exist between either or both of the first client device 208(1) and the second client device 208(2) and the OMFR device 202, or no relationship may exist.

Further, OMFR device 202 is illustrated as being able to access a historical operations maintenance data repository 206(1) and a fault remediation status database 206(2). The operations maintenance and fault remediation module 302 may be configured to access these databases for implementing a method for performing operations maintenance and fault remediation by using artificial intelligence and machine learning techniques to provide self-healing capabilities.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the OMFR device 202 via broadband or cellular communication. Of course, these embodiments are merely exemplary and are not limiting or exhaustive.

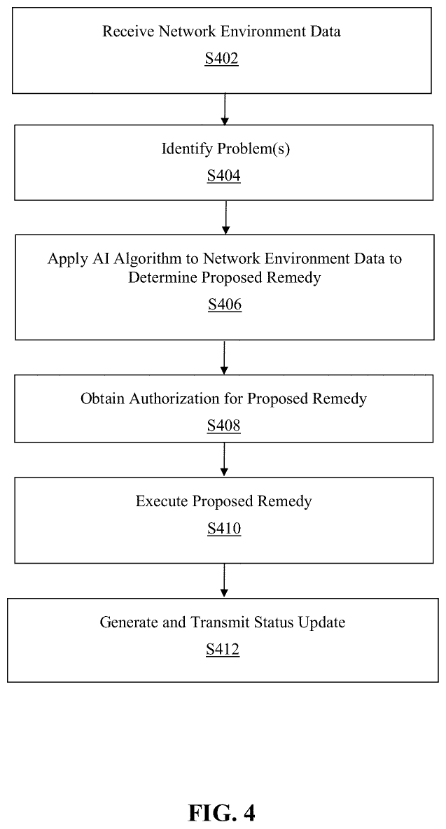

Upon being started, the operations maintenance and fault remediation module 302 executes a process for performing operations maintenance and fault remediation by using artificial intelligence and machine learning techniques to provide self-healing capabilities. An exemplary process for performing operations maintenance and fault remediation by using artificial intelligence and machine learning techniques to provide self-healing capabilities is generally indicated at flowchart 400 in FIG. 4.

In process 400 of FIG. 4, at step S402, the operations maintenance and fault remediation module 302 receives first data that relates to a network environment. In an exemplary embodiment, the first data includes data that relates to one or more applications that are available to users on the network and/or data that identifies a user of an application.

At step S404, the operations maintenance and fault remediation module 302 analyzes the first data in order to identify at least one problem to be addressed. In an exemplary embodiment, the problem may include any one or more of the following types of problems: a user password lock; a user password expiry; a user authorization denial; a Lightweight Directory Access Protocol (LDAP) bind password issue; a browser version issue; a non-supported browser; an application crash; and/or a data anomaly.

At step S406, the operations maintenance and fault remediation module 302 determines a proposed remedy for the identified problem. In an exemplary embodiment, the determination of the proposed remedy is performed by applying an artificial intelligence (AI) algorithm to the first data, where the AI algorithm is trained by using historical network environment data.

At step S408, the operations maintenance and fault remediation module 302 obtains an authorization for executing the proposed remedy. Then, at step S410, the operations maintenance and fault remediation module 302 executes the proposed remedy based on the authorization.

At step S412, the operations maintenance and fault remediation module 302 generates a status message that includes information regarding the status of the problem being addressed, and then transmits the status message to a user that may have been impacted by the problem.

In an exemplary embodiment, an application management bot (also referred to herein as “AMBot”) provides a micro-incident management tool for big data and network environments. The application management bot optimizes business user experiences with personalized self-service capabilities and provides rapid fault remediation with self-healing actions. As a result of increasing demand in the number of users of any particular application, a support team may become overwhelmed with problem resolutions, and in this aspect, the application management bot may assist with automated heuristics, thereby reducing the cost to manage users and applications.

In an exemplary embodiment, the application management bot provides several advantageous features, including: 1) personalized self-service in order to help business users by alerting solutions to known issues; 2) transmitting alerts to specific individuals instead of entire teams; 3) providing a self-healing capability for various applications when outages occur; and 4) assisting support teams to diagnose and remedy problems faster and also to gain predictive insights for preventing issues before they would otherwise occur. Key benefits may include any one or more of the following: 1) optimization of business user experience; 2) reduction in volume of alerts; 3) faster and more accurate fault remediation; 4) proactive detection and resolution of emerging issues that may impact business; 5) drive business outcomes such as revenue and conversion; 6) reduction in human resources that would otherwise be needed for relatively time-consuming tasks, such as problem analysis and remediation; and 7) presentation as a self-service model to application owners, who are empowered to onboard an application and use cases from a web user interface.

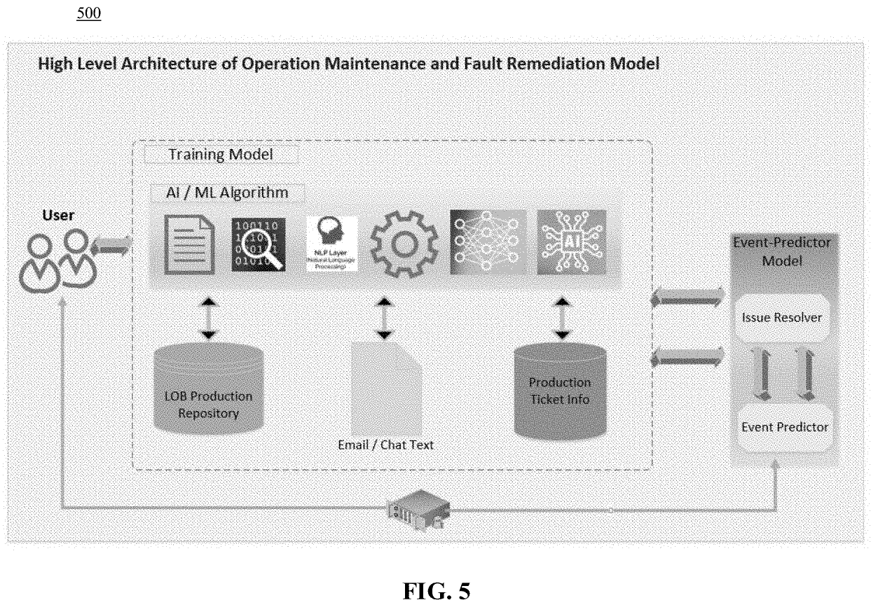

FIG. 5 is a block diagram 500 that illustrates a high level architecture of a system that implements a method for performing operations maintenance and fault remediation by using artificial intelligence and machine learning techniques to provide self-healing capabilities, according to an exemplary embodiment.

Referring to FIG. 5, in an exemplary embodiment, an application management bot executes a self-service/self-healing process that includes several steps. A data agent collects data from an application and infrastructure. Data is pushed to a data agent server, which monitors the status of many data agents. The data agent server pushes data to a Kafka producer topic. Consumer topics collect the data instantly. Based on a consumer topics authorization, the data can be pulled by a worker. The worker separates the data based on server/application, and may wrangle the data.

The data passes through an engine in order to identify user-related issues and/or application-related issues. In an exemplary embodiment, the engine may include the operation maintenance and fault remediation module 302. In an exemplary embodiment, the engine runs in Python with machine learning libraries such as, for example, a clustering K-means library, a hierarchal clustering library, and/or a time series algorithms library.

The worker may look for an email address of a user from corporate data. An artificial intelligence (AI) algorithm may use a natural language processor (NLP) to identify 1) who is the user, 2) what is the problem, 3) where the issue comes from, and 4) what is the proposed solution. Self-service functions include: 1) checking user data for sending email; 2) checking LDAP data for status; and 3) Internet protocol (IP) mapping for a user. Self-healing functions include: 1) sending a decision to Microservices to take action; 2) ID Authorization software deciding whether a requested person is authorized to execute a particular microservice; and 3) when valid authorization is obtained, executing a command for a self-healing action. In an exemplary embodiment, SEP may be used for Skype communication of messages, and Prometheus may be used to monitor end points of an application and then to transfer the data to Kafka.

The following description provides examples of micro-incidents in personalized self-service: 1) User Password lock: Confirm access denied problem acquired from the access logs after performing due diligence for parameters such as email id, Password lock then emails the relevant users with the procedure to reset the password. 2) User Password expiry: Confirm access denied problem acquired from the access logs after performing due diligence for parameters such as email id, Password expiry then emails the relevant users with the procedure to reset the password. 3) User Authorization denials: Confirm authorization denial problem acquired from the access logs after performing due diligence for parameters such as email id, Authorization Denial group then emails the relevant users with the procedure to add a user to the relevant group and contacts the team to get access.

4) LDAP Bind Password issue, i.e., password expiry, password lock, and/or password denied: Confirm LDAP bind problem acquired from the access logs after performing due diligence for parameters such as email id, Authorization Denial group then emails the relevant users with the procedure to add a user to the relevant group. 5) Browser version issue: User login, user puzzled with no proper screen of application, data acquired from the log can perform due diligence and send an email of the issue with the browser version. 6) Non-supported browsers: User login, user puzzled with no proper screen of application, data acquired from the log can perform due diligence and send an email of the issue with the type of browser application that is supported. 7) Anomaly detection: Identification of rare items, events, or observations which raise suspicions by differing significantly with the majority of data. 8) Common issues in the ecosystem: Identify similar error occurrences across different applications to determine the root issue.

The following description provides examples of self-healing use cases: 1) Application crash: Application crashes due to file system fill up; AMBot identifies the file system issue, cleans up the file system, and then when space is cleared, starts the application and alerts the team. 2) Atscale Cube build failure: Rebuild Atscale cube after failure from scheduler. 3) Keytab expiry issue: Password expiry after 90 days; AMBot retrieves a new password; Keytab auto renewal is performed; password synchronization with application and then team is alerted. 4) Spark Thrift crash in cluster: Send alert to worker bot; restart Spark and alert team. 5) Any RUN book procedure: Apply known procedure. 6) Any known issues with procedure.

Accordingly, with this technology, an optimized process for performing operations maintenance and fault remediation by using artificial intelligence and machine learning techniques to provide self-healing capabilities is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing operations maintenance and fault remediation for a network environment, the method being implemented by at least one processor, the method comprising:
receiving, by the at least one processor, first data that relates to the network environment;
analyzing, by the at least one processor, the received first data, and identifying at least one problem to be addressed based on a result of the analyzing;
determining, by the at least one processor, a proposed remedy for the identified at least one problem; and
executing the proposed remedy.

2. The method of claim 1, wherein the analyzing of the first data and the determining of the proposed remedy are performed by applying an artificial intelligence (AI) algorithm to the first data, the AI algorithm being trained by using historical data that relates to the network environment.

3. The method of claim 2, wherein the AI algorithm uses at least one from among a clustering K-means library, a hierarchical clustering library, and a time series algorithms library to analyze the first data.

4. The method of claim 2, wherein the AI algorithm uses a natural language processing technique to identify a user that is impacted by the at least one problem and to determine a source of the at least one problem.

5. The method of claim 1, wherein the first data includes data that relates to a first application and data that identifies a user of the first application.

6. The method of claim 5, further comprising generating a message that indicates a status of the identified at least one problem and transmitting the message to the user.

7. The method of claim 1, further comprising:
before the executing of the proposed remedy, obtaining an authorization for executing the proposed remedy; and
executing the proposed remedy based on the obtained authorization.

8. The method of claim 1, wherein the at least one problem includes at least one from among a user password lock, a user password expiry, a user authorization denial, a Lightweight Directory Access Protocol (LDAP) bind password issue, a browser version issue, a non-supported browser, an application crash, and a data anomaly.

9. The method of claim 1, further comprising:
generating a status message that includes information that relates to a status of the at least one problem; and
transmitting the status message to a user that has been impacted by the at least one problem.

10. A computing apparatus for performing operations maintenance and fault remediation for a network environment, the computing apparatus comprising:
a processor;
a memory; and
a communication interface coupled to each of the processor and the memory,
wherein the processor is configured to:
receive, via the communication interface, first data that relates to the network environment;
analyze the received first data, and identify at least one problem to be addressed based on a result of the analysis;
determine a proposed remedy for the identified at least one problem; and
execute the proposed remedy.

11. The computing apparatus of claim 10, wherein the processor is further configured to perform the analysis of the first data and the determination of the proposed remedy by applying an artificial intelligence (AI) algorithm to the first data, the AI algorithm being trained by using historical data that relates to the network environment.

12. The computing apparatus of claim 11, wherein the AI algorithm uses at least one from among a clustering K-means library, a hierarchical clustering library, and a time series algorithms library to analyze the first data.

13. The computing apparatus of claim 11, wherein the AI algorithm uses a natural language processing technique to identify a user that is impacted by the at least one problem and to determine a source of the at least one problem.

14. The computing apparatus of claim 10, wherein the first data includes data that relates to a first application and data that identifies a user of the first application.

15. The computing apparatus of claim 14, wherein the processor is further configured to generate a message that indicates a status of the identified at least one problem, and to transmit the message to the user via the communication interface.

16. The computing apparatus of claim 10, wherein the processor is further configured to:
before the execution of the proposed remedy, obtain an authorization for executing the proposed remedy; and
execute the proposed remedy based on the obtained authorization.

17. The computing apparatus of claim 10, wherein the at least one problem includes at least one from among a user password lock, a user password expiry, a user authorization denial, a Lightweight Directory Access Protocol (LDAP) bind password issue, a browser version issue, a non-supported browser, an application crash, and a data anomaly.

18. The computing apparatus of claim 10, wherein the processor is further configured to:
generate a status message that includes information that relates to a status of the at least one problem; and
transmit, via the communication interface, the status message to a user that has been impacted by the at least one problem.

19. A non-transitory computer readable storage medium storing instructions for performing operations maintenance and fault remediation for a network environment, the storage medium comprising executable code which, when executed by a processor, causes the processor to:
receive first data that relates to the network environment;
analyze the received first data, and identify at least one problem to be addressed based on a result of the analysis;
determine a proposed remedy for the identified at least one problem; and
execute the proposed remedy.

20. The storage medium of claim 19, wherein when executed by the processor, the executable code further causes the processor to perform the analysis of the first data and the determination of the proposed remedy by applying an artificial intelligence (AI) algorithm to the first data, the AI algorithm being trained by using historical data that relates to the network environment.
